(19) United States
(12) Patent Application Publication
(10) Pub. No.: US 2007/0236738 A1
(43) Pub. Date: Oct. 11, 2007

(54) Image processing device, image processing method, storage medium for storing program and data signal

(75) Inventors: Kenji Hara, Kanagawa (JP); Akira Ishii, Kanagawa (JP); Kenji Koizumi, Kanagawa (JP)

Correspondence Address: MORGAN LEWIS & BOCKIUS LLP, 1111 PENNSYLVANIA AVENUE NW, WASHINGTON, DC, 20004, US

(73) Assignee: Fuji Xerox Co., Ltd.

(21) Appl. No.: 11/598,814

(22) Filed: Nov. 14, 2006

(30) Foreign Application Priority Data
Apr. 10, 2006 (JP) 2006-107390

(51) Int. Cl. G06F 15/00

(52) U.S. Cl. 358/3.02; 358/1.9

(57) ABSTRACT

An image processing device includes: a blank profile storing unit that stores data of a plurality of blank profiles; a threshold storing unit that stores a threshold matrix; a blank profile adding unit that generates blank added image data; a blank added binarization unit that binarizes the plurality of pixels of the blank added image data; a blank profile binarization unit that binarizes the plurality of cells of the blank profile; an output image generation unit that generates output binary image data; and an image output unit that outputs the output binary image data.

### BACKGROUND

1. Technical Field

The present invention relates to image processing devices, image processing methods, storage media for storing programs and data signals.

2. Related Art

As one technique for so-called binarization in which a multi-level image is converted into a binary image, a technique known as halftone processing or halftoning is known. In halftone processing, pixels in an input image correspond to a dot matrix of a certain size. Halftone processing is a technique in which dots are formed in order while giving a higher priority to the center portion in the dot matrix. Thus, a group of dots formed in the center portion of the dot matrix is referred to as “halftone dots” or “clustered dots”. In halftone processing, gray levels are expressed by changing the diameter of the halftone dots.

In an electrophotographic system, an image is formed on paper (print medium) by transferring toner onto the paper. When the diameter of the halftone dots becomes large, the thickness of the toner that is formed in the center portion of the halftone dots increases. The transfer of toner is affected by the geometrical shape of the paper. If colors are expressed by the electrophotographic system, toners of multiple colors (for example the four colors cyan, magenta, yellow and black (CMYK)) need to be transferred on top of one another. That is to say, the transfer of toner of a given color is affected by the geometrical shape of the toner that has been previously transferred. For example, when toner of another color is transferred onto paper that has been provided with an uneven surface by toner of a given color, then the toner image of this other color may be distorted by the uneven surface. That is to say, there is the problem that the image quality may drop due to the multi-layered transfer of toner.

Furthermore, an increase in the thickness of toner that is formed in the center portion of the halftone dots means that the amount of consumed toner also increases. From the viewpoint of lowering costs, it is desirable to decrease the amount of consumed toner.

### SUMMARY

In one aspect of the present invention, an image processing device includes: a blank profile storing unit storing data of multiple blank profiles each representing an extent of a void of a dot formed in accordance with an image of a given gray level value, wherein each blank profile includes multiple cells arranged in an m×n matrix, and wherein each cell includes a gray level value; a threshold storing unit storing a threshold matrix for forming a halftone dot, wherein the threshold matrix includes multiple cells arranged in an m×n matrix, and wherein each cell includes a threshold value for binarization; a blank profile adding unit that generates blank added image data including multiple pixels arranged in an m×n matrix by adding the gray level values of a portion of an input image to be processed respectively to the gray level values of the multiple cells of that blank profile, of the multiple blank profiles stored in the blank profile storing unit, that corresponds to the gray level value of the portion to be processed; a blank added binarization unit that binarizes the multiple pixels of the blank added image data generated by the blank profile adding unit by comparing the gray level value of each pixel with the threshold value of that cell, of the multiple cells of the threshold matrix stored in the threshold matrix storing unit, that is located at the corresponding position, and that generates blank added binary image data including multiple pixels arranged in an m×n matrix; a blank profile binarization unit that binarizes the multiple cells of the blank profile corresponding to the gray level value of the portion to be processed by comparing the gray level value of each cell with the threshold value of that cell, of the multiple cells of the threshold matrix, that is at the corresponding position, and that generates blank binary image data including multiple pixels arranged in an m×n matrix, an output image generation unit that generates output binary image data by subtracting, from the gray level value of each of the multiple pixels of the blank added binary image data generated by the blank added binarization unit, the gray level value of that pixel, of the multiple pixels of the blank binary image data generated by the blank profile binarization unit, that is located at the corresponding position; and an image output unit that outputs the output binary image data generated by the output image generation unit to an image forming apparatus.

### BRIEF DESCRIPTION OF THE DRAWINGS

Exemplary embodiment(s) of the present invention will be described in detail based on the following figures, wherein:

FIG. 1 is a diagram showing the functional configuration of an image processing device according to one exemplary embodiment;

FIG. 2 is a diagram showing an example of a blank profile;

FIG. 3 is a diagram illustrating the hardware structure of the image processing device;

FIG. 4 is a flowchart illustrating a binarization process;

FIG. 5 is a diagram showing an example of a binarization process;

FIG. 6 is a diagram showing an example of input/output characteristics;

FIG. 7 is a diagram showing an example of input/output characteristics for the case that the value of k is changed uniformly;

FIG. 8 is a diagram illustrating the dependency of the coefficient k on the gray level value; and

FIG. 9 is a diagram showing an example of halftone dots formed with the present exemplary embodiment.

### DETAILED DESCRIPTION

The following is an explanation of exemplary embodiments of the present invention, with reference to the accompanying drawings.

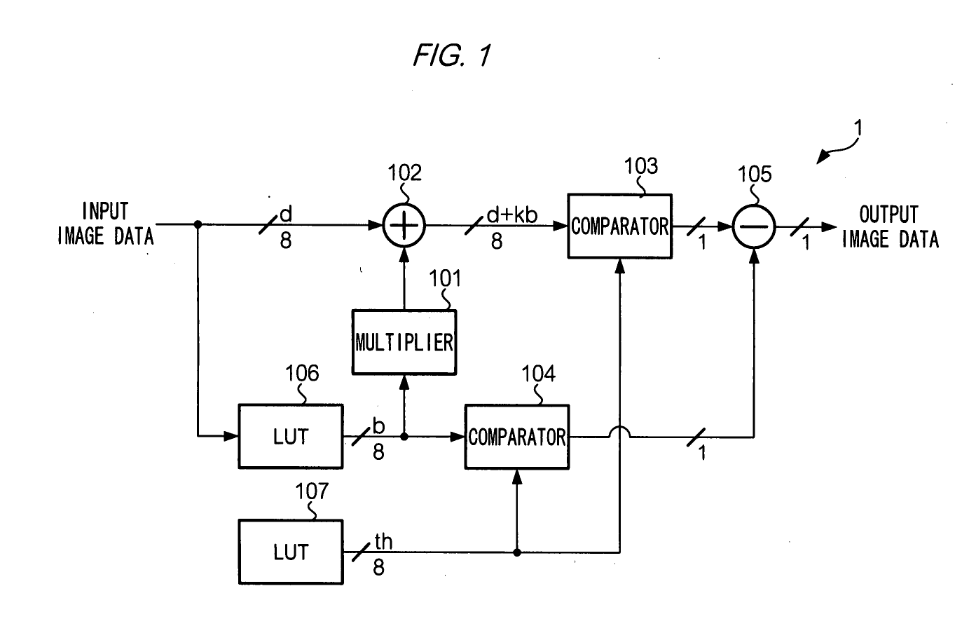

FIG. 1 is a diagram showing the functional configuration of an image processing device 1 according to an exemplary embodiment of the present invention. In this exemplary embodiment, the image data to be processed (input data) is multi-level image data of 8 bits (256 gray levels). It should be noted that the number of gray levels of the input image is not limited to 256 gray levels, and the present invention can be applied to any multi gray-level image of at least three gray levels. The image data includes multiple pixels that are arranged in a matrix. Each pixel has a pixel value of one of the 256 gray levels. In monochrome images, the pixel values have a single component, whereas in RGB images and the like, the pixel values have multiple components in accordance with the color system. The image processing device 1 converts multi-level image data into binary image data. One pixel (input pixel=pixel to be processed) in the multi-level image data is converted into a dot matrix of binary image data. This dot matrix includes multiple pixels (output pixels) arranged in an m×n matrix. The output pixels have pixel values of two gray levels. In other words, the output pixels can express two gray levels, that is, whether a dot is formed or not formed at the corresponding position. In the dot matrix, so-called halftone dots are formed. Halftone dots mean multiple dots that are formed in a concentrated manner in the dot matrix. That is to say, halftone dots are multiple dots that are formed in a cluster arrangement. In the dot matrix, gray levels are basically expressed by the size of the halftone dots.

In related arts, halftone dots mean multiple dots that are formed concentrated in a cluster arrangement, as described above. In the present exemplary embodiment, a technique for forming halftone dots having voids inside them is proposed. Voids are regions in which no dots are formed. Thus, in accordance with the present exemplary embodiment, hollow-structure halftone dots are formed. In the following explanations, halftone dots with voids are referred to as “hollow halftone dots”. Moreover, conventional halftone dots without voids are referred to as “non-hollow halftone dots”.

LUT 106 is a memory in which blank profiles are stored. A blank profile is characteristic data specifying the shape of the void formed inside a halftone dot. The LUT 106 stores multiple such blank profiles. Each of the multiple blank profiles corresponds to a different density. Here, “density” means the gray level value of the pixels to be processed. The blank profiles include the characteristic data and information specifying the corresponding densities.

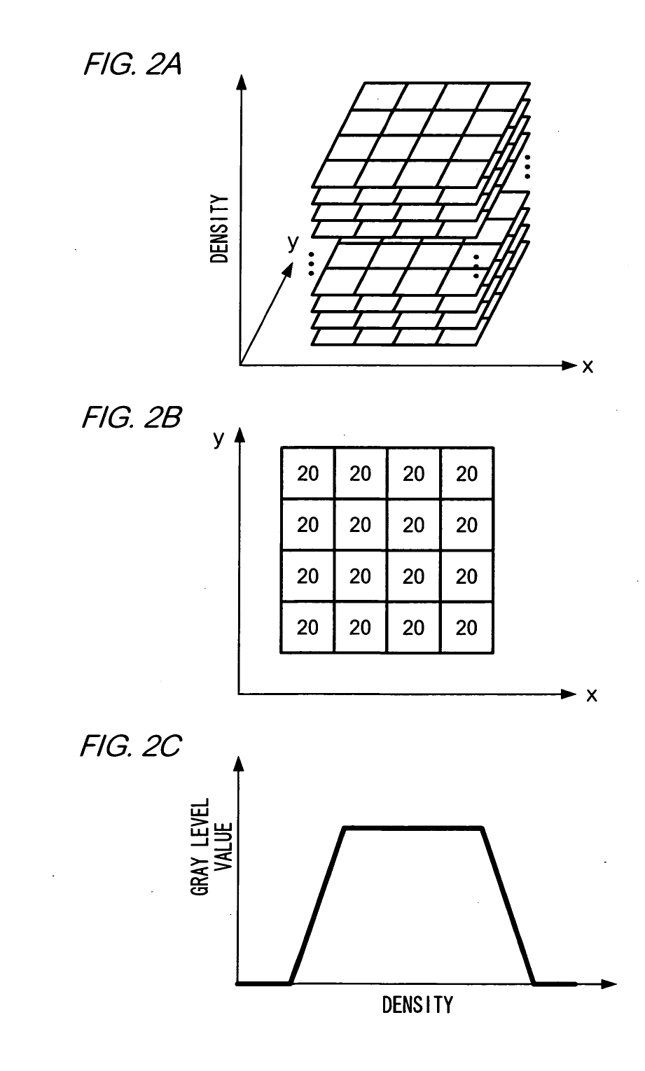

FIG. 2 is a diagram showing an example of a blank profile. Each blank profile has multiple cells that are arranged in an m×n matrix. That is to say, the number of cells of the blank profile is the same as the number of output pixels in the dot matrix of the binary image data. FIG. 2A shows an example in which m=n=4. In FIG. 2A, the blank profiles are constituted by multiple blank profiles, each corresponding to a different density. FIG. 2B shows a blank profile corresponding to a certain density. In FIG. 2B, the vertical axis (y-axis) and the horizontal axis (x-axis) both mark the position of each cell within the blank profile. Moreover, each cell has a gray level value (density or luminance). FIG. 2C shows an example of a profile of gray level values as a function of density. In FIG. 2C, the horizontal axis denotes density and the vertical axis denotes the gray level values of the various cells of the blank profiles. As shown in FIG. 2C, the blank profiles have gray level values that are high in the center portion. Moreover, the blank profiles have gray level values that are zero at the peripheral portions. In the blank profiles, regions with high gray level values tend to become void after binarization, and regions with low gray level values do not tend to become void after binarization.

Let us now turn once again to FIG. 1. LUT 107 is a memory storing a threshold matrix. The threshold matrix includes multiple cells that are arranged in an m×n matrix. That is to say, the number of cells of the threshold matrix and the number of cells of blank profiles is the same as the number of the output pixels in the dot matrix of the binarized image data. Each cell of the threshold matrix contains a threshold value concerning the conversion of the multi-level data into binary data.

A multiplier 101 multiplies that blank profile, of the blank profiles stored in the LUT 106, that corresponds to the gray level value of the pixel to be processed with a coefficient k. More specifically, the multiplier 101 multiplies the gray level value of each of the multiple cells contained in the blank profile with the coefficient k. An adder 102 adds the gray level value of the pixel to be processed to the blank profile that has been multiplied with the coefficient k. More specifically, the adder 102 adds the gray level value of the pixel to be processed to the gray level value of each of the cells in the blank profile that has been multiplied with the coefficient k.

A comparator 103 compares the threshold matrix stored in the LUT 107 with the output of the adder 102, thereby binarizing the blank profile to which the gray level value of the pixel to be processed has been added. More specifically, for each of the multiple cells of the blank profile, the comparator 103 compares the gray level value of the cell with the threshold value of that cell, of the multiple cells of the threshold matrix, that is located at the corresponding position. Here, the corresponding position means the same position in the matrix. For example, when the cell located at the x-th position from the left and the y-th position from the top among the multiple cells of the blank profile is denoted as b(x, y) and the cell located at the x-th position from the left and the y-th position from the top among the multiple cells of the threshold matrix is denoted as th(x, y), then the cell corresponding to b(x, y) is th(x, y).

If the gray level value exceeds the threshold value, then the comparator 103 outputs the binary value “1”. If the gray level value is equal to or lower than the threshold value, then the comparator 103 outputs the binary value “0”. The binary value “1” means that a dot is formed. The binary value “0” means that no dot is formed. The output from the comparator 103 represents solid halftone dots without voids. The output from the comparator 103 is referred to as “blank added binary image data”.

The comparator 104 compares the blank profile corresponding to the gray level value of the pixel be processed with the threshold matrix, thereby binarizing the blank profile. The blank profile processed by the comparator 104 is that blank profile, of the multiple blank profiles stored in the LUT 106, that corresponds to the gray level value of the pixel to be processed. That is to say, this blank profile has not been multiplied with the coefficient k and the gray level value of the pixel to be processed has not been added to it. More specifically, for each of the multiple cells of the blank profile, the comparator 104 compares the gray level value of this cell with the threshold value of that cell, of the multiple cells in the threshold matrix, that is located at the corresponding position. If the gray level value exceeds the threshold value, the comparator 104 outputs the binary value “1”. If the gray level value is equal to or lower than the threshold value, then the comparator 104 outputs the binary value “0”. The output from the comparator 104 indicates the shape of the void in the halftone dot. The output from the comparator 104 is referred to as “blank binary image data”.

A subtracter 105 subtracts the output of the comparator 104 from the output of the comparator 103. That is to say, the subtracter 105 subtracts the blank binary image data from the blank added binary image data. More specifically, for each of the multiple pixels in the blank added binary image data, the subtracter 105 subtracts from the gray level value (density) of the pixel, the gray level value of that pixel, of the multiple pixels of the blank binary image data, that is located at the position corresponding to that pixel. Thus, output binary image data corresponding to the pixel to be processed is generated. The output binary image data includes multiple pixels that are arranged in an m×n matrix. Each pixel has a binary gray level value (i.e. one of two gray levels) indicating whether a dot is formed or not.

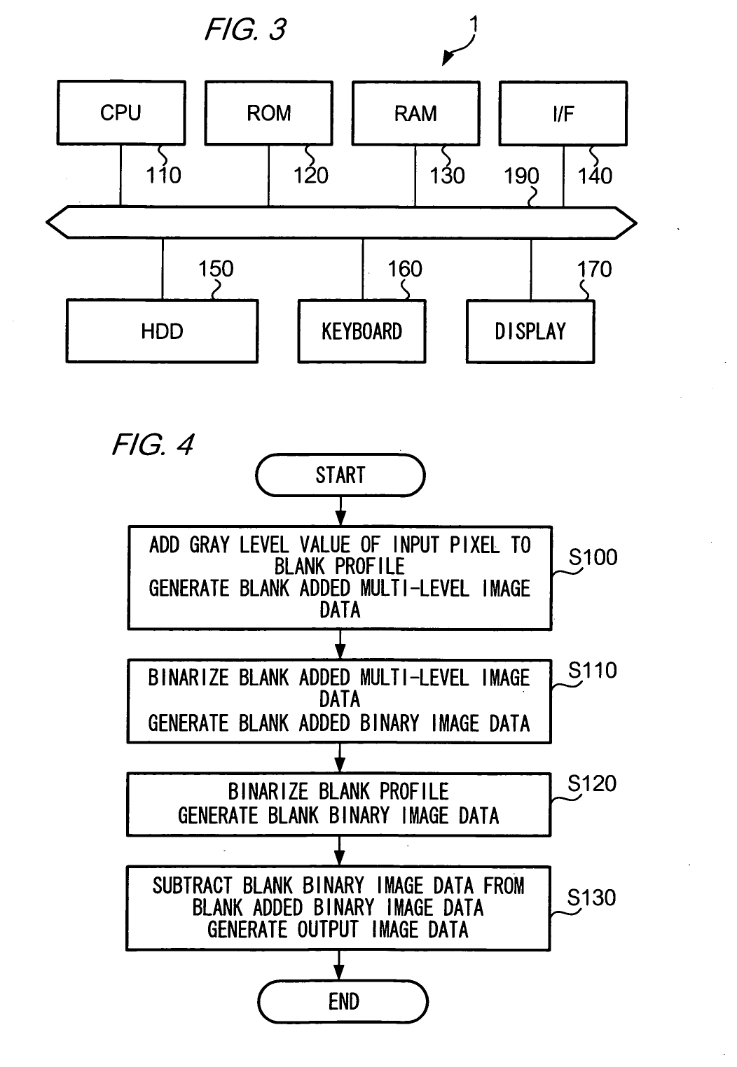

FIG. 3 is a diagram illustrating the hardware structure of the image processing device 1. A CPU 110 is a control section controlling the various structural elements of the image processing device 1. The CPU 110 reads out an image processing program that is stored in a HDD (Hard Disk Drive) 150. A RAM 130 serves as a working area when the CPU 110 executes this program. A ROM 120 stores a program or the like that is necessary to start the image processing device 1. An interface (I/F) 140 is an interface over which the image processing device 1 sends and receives data and control signals to/from other devices. The HDD 150 is a storage device storing various kinds of data and programs. A keyboard 160 and a display 170 serve as a user interface with which the user can operate the image processing device 1. The above-noted structural elements are connected to one another by a bus 190. By executing the image processing program with the CPU 110, the image processing device 1 is provided with the functionality shown in FIG. 1.

FIG. 4 is a flowchart illustrating a binarization process according to the present exemplary embodiment. The HDD 150 stores image data representing an input image to be processed. In the following explanations, one of the multiple pixels included in the input image is image-processed as the pixel to be processed. The CPU 110 specifies one of the multiple pixels as the pixel to be processed, in accordance with a predetermined rule. When the image processing for a given pixel to be processed is finished, the CPU 110 specifies another pixel as the pixel to be processed. Thus, by updating, in order, the pixel to be processed, the CPU 110 image-processes all pixels included in the image data.

First, at Step S100, the CPU 110 generates blank added multi-level image data. This is explained in more detail in the following. The CPU 110 reads out the blank profile b corresponding to the gray level value of the pixel to be processed from the HDD 150. Furthermore, the CPU 110 reads out the coefficient k from the HDD 150. Then, the CPU 110 multiplies the blank profile b with the coefficient k. Then, the CPU 110 adds the gray level value (density d) of the pixel to be processed to the blank profile kb obtained by multiplication with the coefficient k. The thus generated data is referred to as “blank added multi-level image data”. The blank added multi-level image data can be expressed as d+kb.

Next, in Step S110, the CPU 110 binarizes the blank added multi-level data. This is explained in more detail in the following. The CPU 110 reads out the threshold matrix stored in the HDD 150. The CPU 110 compares the blank added multi-level image data with the threshold matrix. The CPU binarizes the blank added multi-level image data in accordance with the result of this comparison. Thus, the CPU 110 generates blank added binary image data.

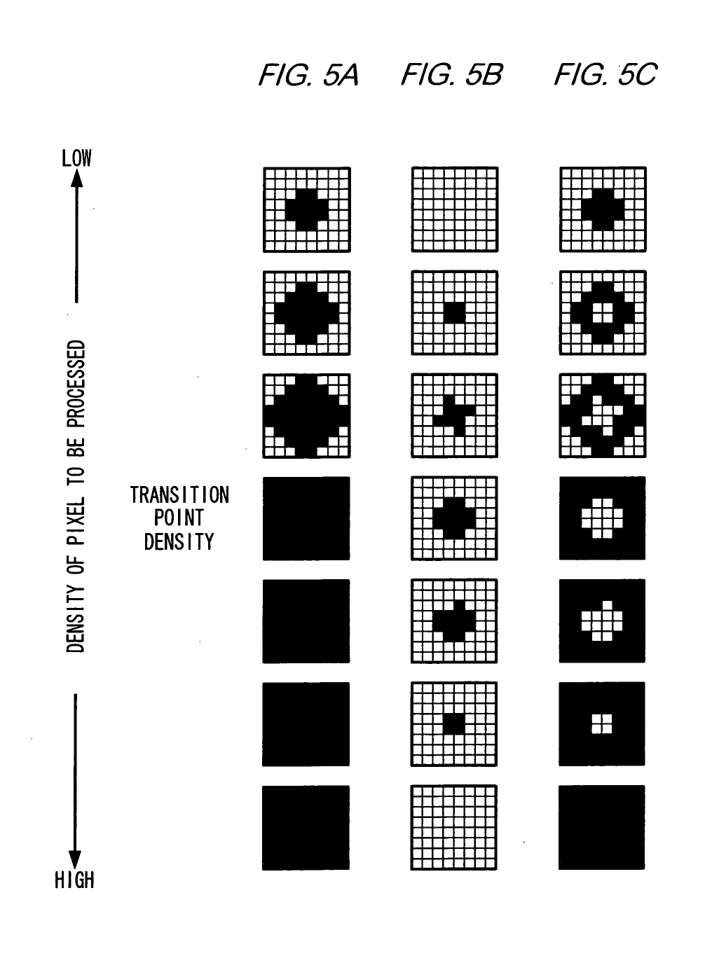

FIG. 5A is an example showing blank added binary image data. The threshold matrix is a matrix in which threshold values for forming so-called halftone dots are stored. If the gray level value of the pixel to be processed is low (if its density is low), then dots are formed in the center portion of the dot matrix. The blank added binary image data represents the halftone dots prior to making the hollow halftone dots hollow. In the present exemplary embodiment, as the gray level value of the pixel to be processed becomes high, the dots are formed such that the size of the halftone dots becomes large. In the present exemplary embodiment, the image that is finally formed is made of hollow halftone dots. Consequently, when the gray level value of the pixel to be processed reaches a certain value (referred to as “transition point density”), the blank added binary image data becomes a pattern in which the entire dot matrix is filled out.

Referring to FIG. 4 again, in Step S120, the CPU 110 binarizes the blank profile b. The CPU 110 reads the blank profile that is stored in the HDD 150. The CPU 110 compares the blank profile with the threshold matrix. The CPU 110 binarizes the blank profile in accordance with the result of the comparison. The binarized blank profile is referred to as “blank binary image data”. The CPU 110 thus generates the blank binary image data.

FIG. 5B is a diagram illustrating an example of the blank binary image data. The blank binary image data represents the void regions in the hollow halftone dots. When the blank binary image data is generated, the same threshold matrix as when generating the blank added binary image data is used. When the gray level value of the pixel to be processed is highest or lowest, the size of the void region is zero, whereas it is greatest when the gray level value of the pixel to be processed is near the transition point density.

Referring to FIG. 4 again, in Step S130, the CPU 110 subtracts the blank binary image data from the blank added binary image data. More specifically, for each of the multiple pixels of the blank added binary image data, the CPU 110 subtracts from the gray level value of that pixel the gray level value of that pixel, of the multiple pixels of the blank binary data, that is located at the position corresponding to that pixel. The data generated by subtracting the blank binary image data from the blank added binary image data is referred to as “output binary image data”. The CPU 110 thus generates the output binary image data. The CPU 110 outputs the generated output binary image data via the I/F 140 to an image forming apparatus (not shown in the figures) or the like.

As explained above, in the present exemplary embodiment, the outer shape of the halftone dots is determined by the blank added binary image data. Moreover, the void region of the halftone dots is determined by the blank binary image data. According to the present exemplary embodiment, the outer shape of the halftone dots and the void regions can be controlled independently. The hollow halftone dots are basically generated by deleting several dots in the center portion of the non-hollow halftone dots and adding the same number of dots as were deleted to the peripheral portion of the halftone dots. Since the number of deleted dots is the same as the number of added dots, the continuity of the input/output characteristics is maintained. However in actuality, even when the number of dots forming the halftone dots is the same, the input/output characteristics of the non-hollow halftone dots according to the conventional techniques may turn out to be different from the input/output characteristics of the hollow halftone dots.

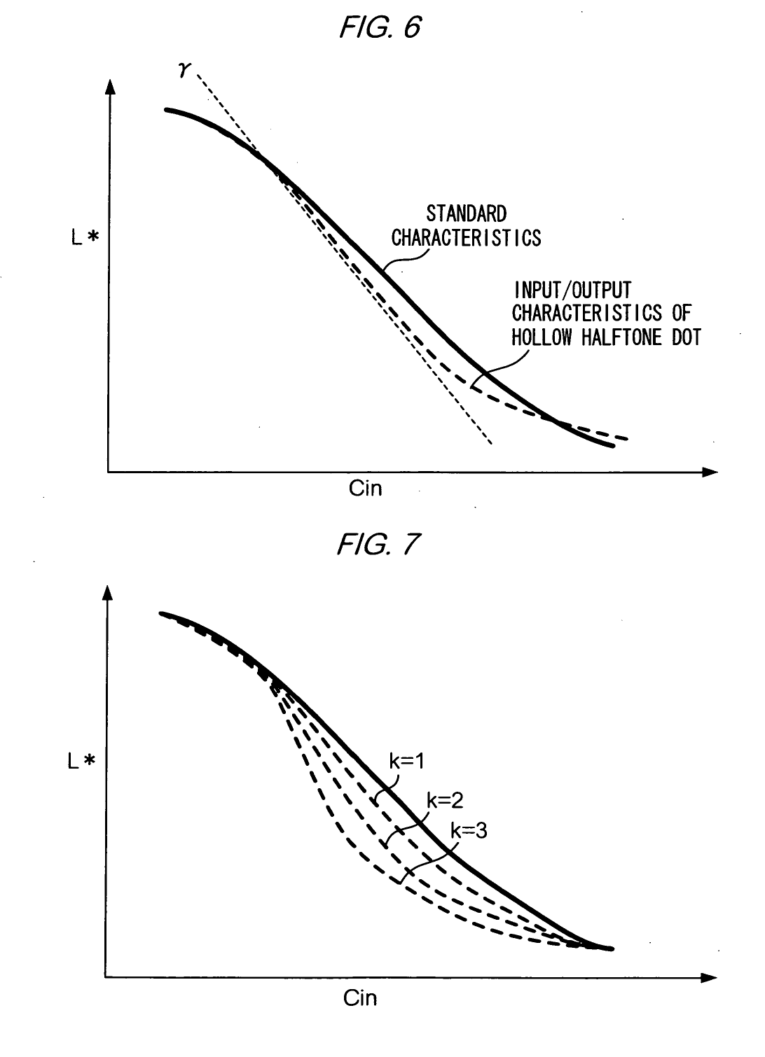

FIG. 6 is a diagram showing an example of the input/output characteristics. In FIG. 6, the horizontal axis denotes the gray level value Cin of the pixel to be processed and the vertical axis denotes the brightness L* as an example of the pixel value of the output pixel. The solid line in FIG. 6 denotes the input/output characteristics (referred to as “standard characteristics”) of the non-hollow halftone dots, and the dotted line shows the input/output characteristics for the case that k=1. In the example shown in FIG. 6, the input/output characteristics of the hollow halftone dots exhibit the same brightness L* as the standard characteristics in the region in which Cin indicates a low density, and the brightness L* is lower than the standard characteristics in the region where Cin indicates a high density. Thus, the input/output characteristics of the hollow halftone dots have a poorer linearity than the standard characteristics.

Here, the slope γ is introduced as a parameter for evaluating the input/output characteristics of the hollow halftone dots. γ indicates the slope of the input/output characteristics of the hollow halftone dots in the vicinity of the center of Cin in the region where those input/output characteristics become substantially linear. Ideally, the slope γ is gentle, that is, it is desirable that the linear region is long. In FIG. 6, the input/output characteristics are shown for the case that k is constant at k=1, regardless of the gray level value of the pixel to be processed, but it is possible to control the input/output characteristics by controlling the value of k.

FIG. 7 is a diagram showing an example of the input/output characteristics for the case that the value of k is changed uniformly. When the value of k is increased, the size of the hollow region stays the same, but the outer shape of the hollow halftone dots becomes bigger. Consequently, the input/output characteristics are shifted towards lower brightness as the value of k is increased. Thus, by changing the value of k, it is possible to control the shape of the input/output characteristics. Here, if k=0, no void region is formed in the hollow halftone dots and it is possible to form halftone dots that are the same as non-hollow halftone dots.

FIG. 7 illustrates the case that k is constant regardless of the gray level value of the pixel to be processed, but it is possible to change k depending on the gray level value of the pixel to be processed.

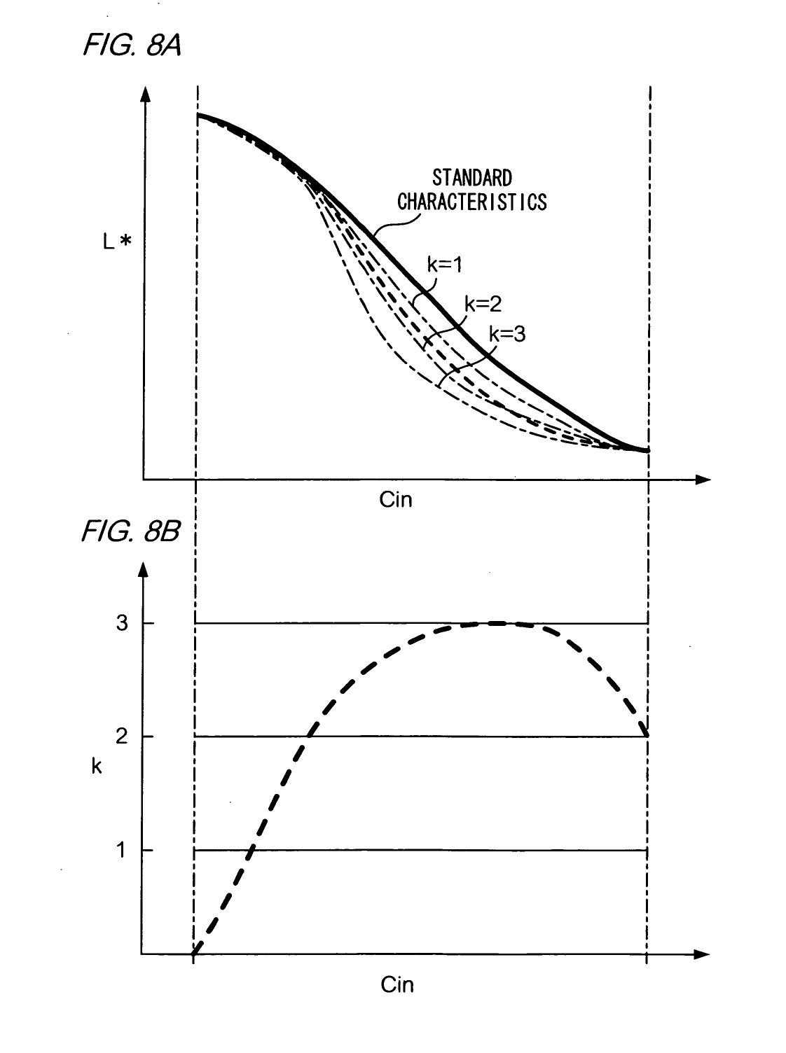

FIG. 8 illustrates a case in which the coefficient k is set such that it changes with the gray level value. FIG. 8A shows the standard characteristics the input/output characteristics (for k=1, 2, 3) of the hollow halftone dots, and FIG. 8B shows the dependency of the coefficient k of the gray level value Cin. In FIG. 8B, the solid lines denote the case that the input/output characteristics of the hollow halftone dots are set to be constant (k=1, 2, 3) and the broken line denotes the case that the input/output characteristics of the hollow halftone dots are caused to change with Cin. Thus, by setting the value of the coefficient k to change with the gray level value Cin, it is possible to control the input/output characteristics of the hollow halftone dots more smoothly.

The image processing device 1 stores the coefficient k obtained as described above in the ROM 120 or the HDD 150. The coefficient k may be stored in a look-up table, or it may be stored as parameters specifying a function indicating the dependency of the coefficient k on Cin. The CPU 110 determines the value of the coefficient k by looking up this look-up table or the function. The CPU 110 performs the above-noted calculation using the value of the determined coefficient k.

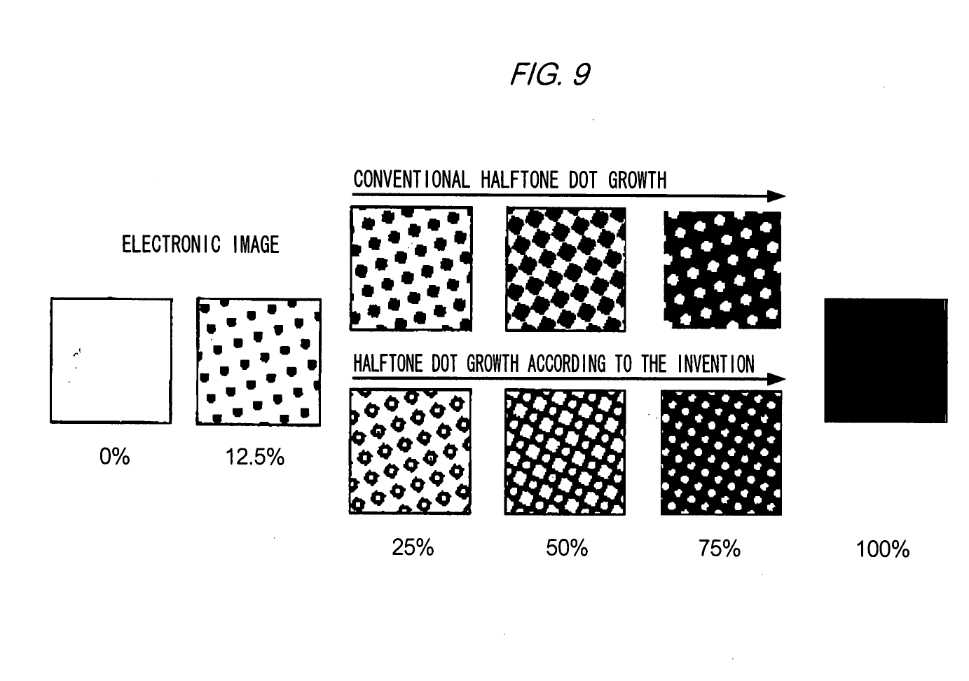

FIG. 9 is a diagram showing an example of halftone dots formed by the present exemplary embodiment. With the present exemplary embodiment, it is possible to form hollow halftone dots. Thus, the thickness of the toner layer inside the halftone dots can be made thinner. Consequently, it is possible to improve the transfer properties for multiple layers, that is, the image quality. Moreover, by increasing the proportion of the coloring material contributing to the absorption of light, it is possible to reduce the amount of toner that is consumed. Furthermore, in the present exemplary embodiment, it is possible to independently control the outer shape of the halftone dots and the shape of the void region. Therefore, it is possible to realize a higher gray level reproducibility.

It should be noted that the present invention is not limited to the above-described exemplary embodiment, and various modifications are possible.

In the above-described exemplary embodiment, the functional configuration shown in FIG. 1 is realized by the CPU 110 executing an image processing program, but the functional configuration shown in FIG. 1 may also be realized as hardware using electronic circuitry corresponding to the various functional structural elements.

Furthermore, in the above-described exemplary embodiment, it was explained that one pixel of the multiple pixels constituting the input image data is subjected to image processing and the pixel to be processed is successively changed, but there is no limitation to image processing in units of one pixel at a time. It is also possible to perform image processing of the input image data in units of images constituted by multiple pixels a×a or a×b (where a and b are both positive integers). In this case, it is possible to use for example an average gray level value of the unit image instead of the gray level value of the pixel to be processed. Furthermore, if a=m and b=n, then it is possible to generate blank added image data by adding the gray level value (density) of each pixel of the unit image arranged in an m×n matrix to the gray level value of the cell located at the corresponding position in the blank profile.

Furthermore, in the above-described exemplary embodiment, the CPU 110 multiplies the blank profile with the coefficient k when generating the blank added multi-level image data, but it is also possible to omit this step. That is to say, by adding the density d of the pixel to be processed to the blank profile b, the CPU 110 may also generate blank added multi-level image data d+b. It should be noted that the processing result of this exemplary embodiment is the same as the processing result in the case when k=1 in the exemplary embodiment in which a multiplication with the coefficient k is performed. Furthermore, it is also possible to use two sets multiple blank profiles, which respectively correspond to different densities, and to use a set of different blank profiles to generate blank added binary image data and blank binary image data.

Furthermore, in the above-described exemplary embodiment, as an example of a blank profile corresponding to a given density, an example was explained, which has the same gray level value for all cells, but it is also possible to use a blank profile that is smaller than m×n, or to repeatedly use a blank profile in accordance with a predetermined rule for the processing of a unit image of m×n size. For example, it is possible to repeatedly use a blank profile whose cell size is 1, and to use the same blank profile for the same processing of all unit images. Moreover, in the above-described exemplary embodiment, the gray level values of the various cells of the blank profile corresponding to a given density are not limited to all having the same value.

Furthermore, in the above-described exemplary embodiment, the image processing device and the image forming apparatus were explained as separate devices, but they may also be constituted by a single device. That is to say, an image forming apparatus, such as a printer, a fax machine, a copier, or a multi-functional device, may be provided with the functionality of the above-described image processing device.

Furthermore, the image processing program may be stored and provided on a storage medium, such as a CD-ROM (Compact Disk Read Only Memory).

What is claimed is:

1. An image processing device, comprising:
a blank profile storing unit that stores data of a plurality of blank profiles each representing an extent of a void of a dot formed in accordance with an image of a given gray level value, each blank profile including a plurality of cells arranged in an m×n matrix, each cell including a gray level value;
a threshold storing unit that stores a threshold matrix for forming a halftone dot, the threshold matrix including a plurality of cells arranged in an m×n matrix, each cell including a threshold value for binarization;
a blank profile adding unit that generates blank added image data including a plurality of pixels arranged in an m×n matrix by adding the gray level values of a portion of an input image to be processed respectively to the gray level values of the plurality of cells of that blank profile, of the plurality of blank profiles stored in the blank profile storing unit, that corresponds to the gray level value of the portion to be processed;
a blank added binarization unit that binarizes the plurality of pixels of the blank added image data generated by the blank profile adding unit by comparing the gray level value of each pixel with the threshold value of that cell, of the plurality of cells of the threshold matrix stored in the threshold storing unit, that is located at the corresponding position, and that generates blank added binary image data comprising a plurality of pixels arranged in an m×n matrix;
a blank profile binarization unit that binarizes the plurality of cells of the blank profile corresponding to the gray level value of the portion to be processed by comparing the gray level value of each cell with the threshold value of that cell, of the plurality of cells of the threshold matrix, that is at the corresponding position, and that generates blank binary image data comprising a plurality of pixels arranged in an m×n matrix,
an output image generation unit that generates output binary image data by subtracting, from the gray level value of each of the plurality of pixels of the blank added binary image data generated by the blank added binarization unit, the gray level value of that pixel, of the plurality of pixels of the blank binary image data generated by the blank profile binarization unit, that is located at the corresponding position; and
an image output unit that outputs the output binary image data generated by the output image generation unit to an image forming apparatus.

2. The image processing device according to claim 1, wherein for any two cells of the plurality of cells arranged in the m×n matrix of the blank profiles, the gray level values of the cells corresponding to the gray level value of the image match.

3. The image processing device according to claim 1, wherein the blank profile adding unit adds the gray level value of the portion to be processed to the data of the blank profile after the gray level value of each of the plurality of cells of the blank profile has been multiplied with a coefficient k.

4. The image processing device according to claim 3, wherein the coefficient k is a function of the gray level value of the portion to be processed.

5. The image processing device according to claim 4, wherein the coefficient k is a coefficient that is determined so as to compensate for a difference between ideal input/output characteristics and actual input/output characteristics of the image forming apparatus.

6. An image processing method comprising:
storing data of a plurality of blank profiles each representing an extent of a void of a dot formed in accordance with an image of a given density;
storing a threshold matrix for forming a halftone dot;
generating blank added image data by adding, with respect to multi-level image data of an input image, the data of that blank profile, of the plurality of blank profiles, that corresponds to the gray level value of this input image to the input image data;
generating blank added binary image data by comparing the blank added data with the threshold matrix;
generating blank binary image data by comparing the blank profile corresponding to the gray level value of the input image with the threshold matrix;
generating output binary image data corresponding to the input image by subtracting the blank binary image data from the blank added binary image data; and
outputting the output binary image data to an image forming apparatus.

7. A computer readable storage medium storing a program causing a computer to execute a process, the process comprising:
storing data of a plurality of blank profiles, each representing an extent of a void of a dot formed in accordance with an image of a given density;
storing a threshold matrix for forming a halftone dot;
generating blank added image data by adding, with respect to multi-level image data of an input image, the data of that blank profile, of the plurality of blank profiles, that corresponds to the gray level value of this input image to the input image data;
generating blank added binary image data by comparing the blank added data with the threshold matrix;
generating blank binary image data by comparing the blank profile corresponding to the gray level value of the input image with the threshold matrix;
generating output binary image data corresponding to the input image by subtracting the blank binary image data from the blank added binary image data; and
outputting the output binary image data to an image forming apparatus.

8. A computer data signal embodied in a carrier wave for enabling a computer to perform a process, the process comprising:
storing data of a plurality of blank profiles, each representing an extent of a void of a dot formed in accordance with an image of a given density;
storing a threshold matrix for forming a halftone dot;
generating blank added image data by adding, with respect to multi-level image data of an input image, the data of that blank profile, of the plurality of blank profiles, that corresponds to the gray level value of this input image to the input image data;
generating blank added binary image data by comparing the blank added data with the threshold matrix;
generating blank binary image data by comparing the blank profile corresponding to the gray level value of the input image with the threshold matrix;
generating output binary image data corresponding to the input image by subtracting the blank binary image data from the blank added binary image data; and
outputting the output binary image data to an image forming apparatus.
